(19) United States
(12) Patent Application Publication
(10) Pub. No.: US 2023/0264787 A1
(43) Pub. Date: Aug. 24, 2023

(54) Training Device for Hydrofoil Watercraft and Methods of Use Thereof

(71) Applicant: MHL Custom, Inc., Isabela, PR (US)

(72) Inventors: Nicholas Leason, Aguadilla, PR (US); Stephen Willes, Isabela, PR (US)

(73) Assignee: MHL Custom, Inc., Isabela, PR (US)

(21) Appl. No.: 18/173,913

(22) Filed: Feb. 24, 2023

Related U.S. Application Data
(60) Provisional application No. 63/313,486, filed on Feb. 24, 2022.

(51) Int. Cl. B63B 1/28; G05D 1/08

(52) U.S. Cl. CPC B63B 1/283; G05D 1/0875

(57) ABSTRACT

A training hydrofoil system for connection with a watercraft comprises a first wing including at least one adjustable surface and a second wing including at least one adjustable portion. The system further includes a fuselage extending longitudinally and the first and second wing connected to the fuselage and extending latitudinally relative to the fuselage, the fuselage including an attachment feature for attaching to the watercraft. The system further includes an electronic control unit capable of actuating at least one of the adjustable surface and adjustable portion to modify a course of the watercraft, and a power source. Both the power source and the electronic control unit are positioned in the fuselage.

### CROSS-REFERENCE

This application claims the benefit of the filing date of U.S. Provisional Patent Application No. 63/313,486 filed on Feb. 24, 2022, the disclosure of which is hereby incorporated herein by reference.

### BACKGROUND OF THE INVENTION

Personal watercrafts are typically operated by riding along the surface of a body of water. For example, the watercraft can glide on the water along its hull. Alternatively, a watercraft can include at least one hydrofoil that provides lift to the watercraft such that its hull is lifted above its typical waterline during operation. The hull may even be lifted completely above the water surface. To achieve such lift, the watercraft can move through the water along its hull until enough speed is attained for a sufficient force to be applied to the hydrofoil(s) of the watercraft for the watercraft to be lifted above its normal waterline and supported by the hydrofoil(s).

Hydrofoil watercrafts offer a unique experience to riders because they allow the watercraft to gain greater speed, to efficiently hold that speed, and to feel less turbulence at the water surface and more like the rider is floating through the air. However, certain hydrofoil watercrafts, such as a hydrofoil surfboard, have steep learning curves for beginner riders. For example, a beginner rider on a hydrofoil surfboard needs familiarity with riding a standard surfboard before adding a foiling element and an electric propulsion element. The same learning curve would apply for other watercrafts the rider may wish to ride, such as a windsurfing board, a sailboat, a jet ski, etc.

Current hydrofoil watercrafts may hinder a beginner due to both the skill required in learning to ride the watercraft and the cost associated with obtaining the watercraft. A rider seeking to use a personal watercraft with a hydrofoil needs to obtain a watercraft that already has a hydrofoil and propulsion unit attached thereto. As the beginner progresses and desires to ride other watercrafts with a hydrofoil, the beginner needs to obtain entirely new watercrafts with attached hydrofoils. These costs can in some instances become prohibitive to potential new users getting into the activity. Similarly, current hydrofoil equipment is not just expensive, but also requires a certain level of skill that a beginner may not have—resulting in the beginner not using the equipment or deeming it not worth the trouble in the first place. Alternatively, if such a beginner invests in equipment geared towards the beginner user, they are back to the first issue of requiring an investment of a whole new hydrofoil watercraft geared towards users with more experience, likely within a short period of time after the first purchase.

Further, current hydrofoil watercrafts limit riders by housing electronics, such as batteries and a control module, in the watercraft. Those electronics then communicate with a motor located on a strut or on the hydrofoil itself. This poses problems relating to the cooling of the batteries, to the interconnectivity of various sensors within the hydrofoil, and to the modification of various electronic components to achieve different ride settings. Thus, further improvements in hydrofoil technology are desired to assist in introducing new users to the activity and to provide for cost-effective and efficient modification to a hydrofoiling watercraft.

### BRIEF SUMMARY OF THE INVENTION

The present disclosure generally relates to hydrofoils that are interchangeable with and attachable to personal watercrafts. According to an embodiment of the invention, a training hydrofoil system for connection with a watercraft comprises a first wing including at least one adjustable surface; a second wing including at least one adjustable surface; a fuselage extending longitudinally and the first wing and the second wing connected to the fuselage and extending latitudinally relative to the fuselage, the fuselage including an attachment feature for attaching to the watercraft; an electronic control unit capable of actuating the at least one adjustable surface to modify a course of the watercraft; and a power source, the power source and the electronic control unit are positioned in the fuselage.

In another embodiment, the power source is a battery.

In another arrangement, the system comprises at least one sensor and the at least one sensor is at least one of a Lidar sensor, barometric pressure sensor, gyroscope, and an ultrasonic sensor.

In another embodiment, the sensor is configured to determine at least a depth of the system in water, surface conditions of the water, an angle of the watercraft corresponding to a roll, pitch, and yaw axis, and a velocity of the watercraft, and to communicate a corresponding output to the electronic control unit.

In a further embodiment, the sensor is capable of communicating with the electronic control unit to provide data to the electronic control unit and the electronic control unit is capable of using the data to actuate the at least one adjustable surface to modify the course of the watercraft.

In another aspect, the first wing is positioned towards a leading portion of the system relative to the second wing, and the first wing is configured to provide lift to the system.

In another aspect, the at least one adjustable surface of the first wing includes two ailerons, one aileron positioned along trailing portions of the first wing on each side of the fuselage and configured to independently rotate based on a signal from the electronic control unit.

In another embodiment, the second wing is positioned towards a trailing portion of the system relative to the first wing, and the second wing is configured to provide horizontal stabilization to the system.

In another embodiment, the at least one adjustable portion of the second wing includes two elevators, one elevator positioned on each side of the fuselage and each elevator configured to independently rotate based on a signal from the electronic control unit.

In yet another embodiment, a vertical stabilizing fin is positioned at a rear end of the fuselage with at least one rudder positioned thereon, the at least one rudder configured to rotate to provide vertical stabilization to the system.

In another aspect, the sensor is configured to communicate with the electronic control unit to determine a stabilization pattern and a modified course of the watercraft and to actuate the at least one adjustable surface, the at least one adjustable portion, and the at least one rudder to control a roll, pitch, and yaw of the watercraft.

In another embodiment, the system comprises a pitot tube positioned in the fuselage.

In another embodiment, the attachment feature is a quick-connect attachment configured to receive a strut.

In a further embodiment, the quick-connect attachment comprises clips.

According to another embodiment of the invention, a hydrofoil system for attaching to a watercraft comprises a first wing including at least one aileron; a second wing including at least one elevator; a fuselage extending longitudinally between the first wing and the second wing and connected to the first wing and the second wing, the first wing and second wing extending latitudinally relative to the fuselage; at least one sensor; an electronic control unit capable of actuating the at least one aileron and at least one elevator to modify a course of the watercraft; and a power source, the power source and the electronic control unit positioned in the fuselage.

In another arrangement, the system further comprises a vertical stabilizer extending from the fuselage and including at least one rudder configured to rotate based on an input from the electronic control unit.

In another embodiment, the electronic control unit and the power source are positioned in separate waterproof compartments within the fuselage.

In another aspect, the waterproof compartments are separated by bulkheads.

In another aspect, the system comprises at least one servo motor for each of the at least one aileron, at least one elevator, and at least one rudder, the at least one servo motor is in communication with the electronic control unit.

In a further aspect, the electronic control unit communicates to the at least one servo motor via Bluetooth.

In another aspect, the system comprises a strut removably attachable to the fuselage.

According to another embodiment, a method of operating a hydrofoil comprises powering the hydrofoil from a power source positioned in a fuselage of the hydrofoil; sensing an orientation of the hydrofoil via at least one sensor located in the hydrofoil; communicating the orientation of the hydrofoil from the at least one sensor to an electronic control unit positioned in the fuselage; actuating a least one aileron on a first wing based on the orientation of the hydrofoil, the first wing extending transversely to a longitudinal axis of the fuselage and connected to the fuselage; and actuating at least one elevator on a second wing based on the orientation of the hydrofoil, the second wing extending transversely to a longitudinal axis of the fuselage and attached to the fuselage.

In another embodiment, the method further comprises actuating at least one rudder on a vertical stabilizer based on the orientation of the hydrofoil, the vertical stabilizer positioned on a rear end of the fuselage and orthogonally extending from the fuselage.

In a further embodiment, the method further comprises determining a stabilization correction based on the orientation of the hydrofoil and rotating at least one of the aileron, elevator, and rudder to stabilize the hydrofoil.

### BRIEF DESCRIPTION OF THE DRAWINGS

These and other features, aspects, and advantages of the present invention will become better understood with regard to the following description and accompanying drawings of exemplary embodiments.

FIG. 1 is a perspective view of one embodiment of a hydrofoil pod.

FIG. 2 is an exemplary exploded view of the hydrofoil pod of FIG. 1.

FIG. 3 is another exemplary exploded view of the hydrofoil pod of FIG. 1.

FIG. 4 is a side view of the hydrofoil pod of FIG. 1 showing certain inner features within a fuselage.

FIG. 5 is a top view of the fuselage and front wing of the hydrofoil pod of FIG. 1.

FIG. 6 is a side view of a portion of the fuselage of the hydrofoil pod of FIG. 1.

FIG. 7 is a perspective view of the nose region of the hydrofoil pod of FIG. 1 showing certain internal features within the fuselage.

FIG. 8 is a perspective view of a rear wing of the hydrofoil pod of FIG. 1.

FIG. 9 is a rear perspective view showing an embodiment of a push-pull rod mechanism for the elevator on the rear wing.

FIG. 10 is a perspective view of another embodiment of a hydrofoil pod including a vertical stabilizing fin and rudder.

FIG. 11 is a perspective view showing the hydrofoil pod of FIG. 1 engaged in a roll maneuver.

FIG. 12 is a perspective view showing the hydrofoil pod of FIG. 1 engaged in a pitch maneuver.

FIG. 13 is a perspective view showing the hydrofoil pod of FIG. 10 engaged in a yaw maneuver.

FIG. 14 is a perspective view of one embodiment of a configuration where the hydrofoil pod of FIG. 1 is attached to a strut and a watercraft.

### DETAILED DESCRIPTION

As used herein, when referring to the watercraft, directional terms are from the point of view of the center of the watercraft. The terms “left,” “right,” “up,” or “down” means a left, right, up, or down direction from the center of the watercraft. “Clockwise” and “counterclockwise,” means the rotation of the watercraft or a part of the watercraft about an X-, Y-, or Z-axis as viewed from the center of the watercraft. “Roll” rate or angle means rotation about the X-axis, “pitch” rate or angle means rotation about the Y-axis, and “yaw” rate or angle means rotation about the Z-axis. Illustrated throughout is an exemplary watercraft 92 shown as a surfboard. However, the present disclosure is not limited only to surfboards and can thus be used in combination with other types of watercrafts, such as windsurf boards, jet skis, sailboats, powerboats, wakeboards, kiteboards, and the like.

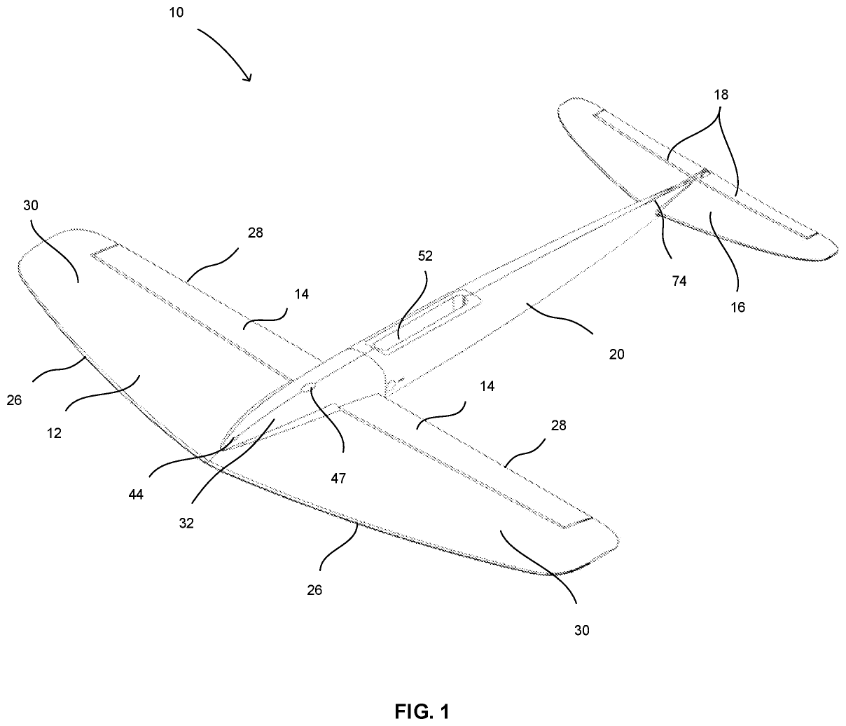

FIG. 1 depicts an embodiment of a hydrofoil pod 10 according to the present disclosure. Hydrofoil pod 10 generally includes a front wing 12, also referred to as a first wing, with at least one aileron 14 thereon, a rear wing 16, also referred to as a second wing, with at least one elevator 18 thereon, a fuselage 20 extending longitudinally between the front wing 12 and rear wing 16, an electronic control unit (ECU) 22, and a power source 24. Each of these components will be described in further detail below.

Continuing with this embodiment, front wing 12 extends in a direction transverse to the longitudinal axis of fuselage 20. Front wing 12 has a leading surface 26 and a trailing surface 28 with a body portion 30 of the first wing extending therebetween. Leading surface 26 is shaped in a generally parabolic manner, similar to a wing on an airplane. In turn, trailing surface 28 generally tapers to an edge. Body portion 30 has a convexly-curved surface (positive camber) along its upper edge and a cambered surface along its bottom edge, albeit with a smaller camber value than the upper edge. This general shape provides lift to the surface of front wing 12 when front wing 12 moves through water. Although the wing shape described above is substantially similar to the shape of a conventional airplane wing, other wing shapes, such as delta wings or the shapes of wings in supercritical airfoils, are also envisioned.

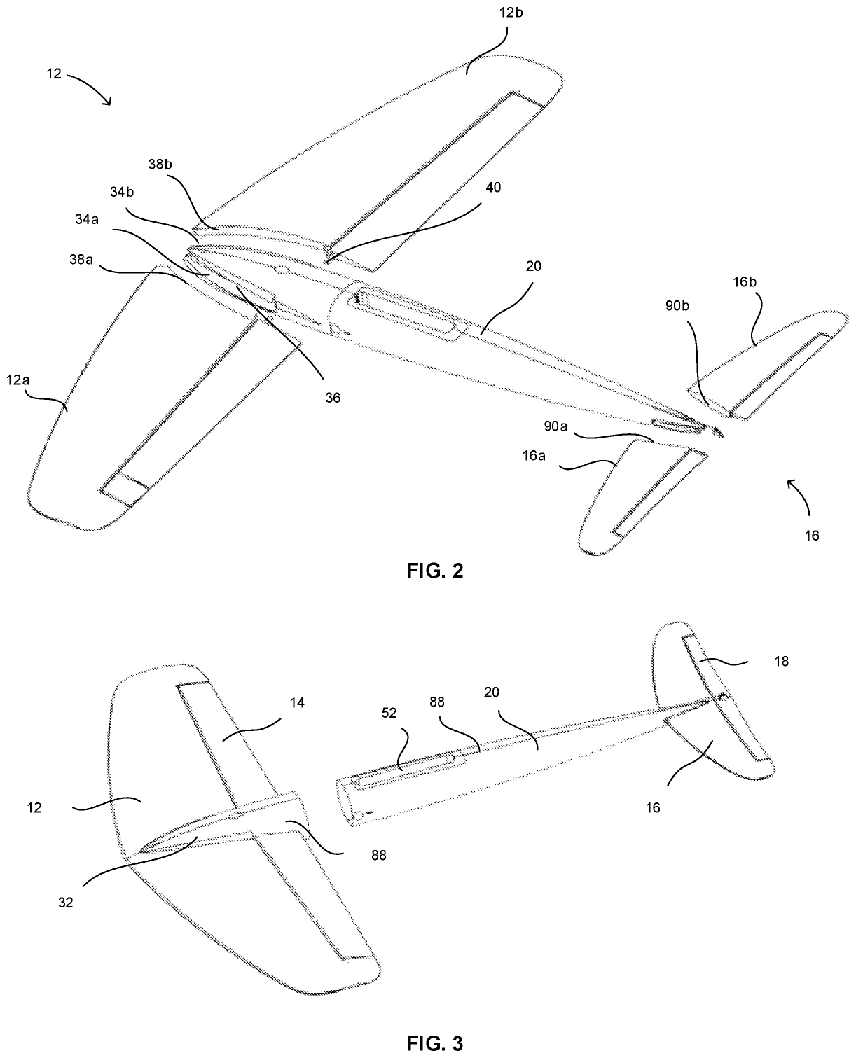

FIG. 2 shows one embodiment of an exemplary exploded view of front wing 12 and potential assembly points for various parts to create hydrofoil pod 10. Front wing 12 includes two wings 12a, 12b, each transversely extending from a nose 32 of fuselage 20. Nose 32 includes groove 34a, 34b on each of its lateral sides, each groove corresponding to the appropriate wing. Grooves 34a, 34b wrap almost entirely or entirely around nose 32. A connection surface 36 is included within groove 34a, 34b, and is adapted to mate with a corresponding opening 38a, 38b in each wing 12a, 12b. Connection surface 36 may be a tab or another shape configured to mate with openings 38a, 38b and may extend entirely through a transverse direction of nose 32. Alignment tabs 40 may also be provided. Alignment tabs 40 extend from each wing toward fuselage 20 and assist in alignment of wings 12a, 12b with nose 32 of fuselage 20. In use, front wings 12a, 12b preferably attach to fuselage 20 without the need for fasteners or other hardware—for example as pressure fits, clips, snaps, other attachment types known in the art, or any combination thereof.

Front wing 12 includes a pair of adjustable surfaces 14, herein referred to as ailerons 14, one aileron on each side of fuselage 20 along trailing edge 28 of front wing 12. Each aileron 14 is rotatable relative to body portion 30 of the front wing 12. The purpose of ailerons 14 is to change the roll of the hydrofoil pod 10 about the X-axis as hydrofoil pod 10 moves through the water. Ailerons 14 may be attached to front wing 12 by any hinge mechanism known in the art. For example, ailerons 14 may include holes extending latitudinally therethrough and front wing 12 may include pins that extend through the holes so that ailerons 14 may rotate thereabout. Importantly, each of the ailerons 14 can rotate independently of each other and typically rotate in the opposite direction of each other. For example, when the right aileron on wing 12b rotates up, the left aileron on wing 12a typically rotates down. FIG. 2 illustrates a pair of ailerons 14. However, other designs, such as a continuous aileron spanning the length of the front wing, or a plurality of ailerons spaced apart from each other along the trailing edge of the front wing, are also envisioned.

In an alternative embodiment, as illustrated in FIG. 3, front wing 12 may be formed of unitary construction along with the remaining elements of hydrofoil pod 10, or it may be formed as its own element, i.e., not split into two separate wing pieces 12a, 12b that attach to nose 32 of fuselage 20, and then assembled to the rest of hydrofoil pod 10. If front wing 12 is assembled to the remaining elements of hydrofoil pod 10, it may include a receiving portion to receive a nose 32 of fuselage 20. The receiving portion may be conical or another shape configured to engage with nose 32 of fuselage 20. Preferably, front wing 12 attaches to nose 32 of fuselage without the need for fasteners. This could be accomplished by employing pressure fits, clips, snaps, other attachment types known in the art, or any combination thereof. Alternatively, fasteners, such as screws or rivets, may also be used to attach front wing 12 to fuselage 20.

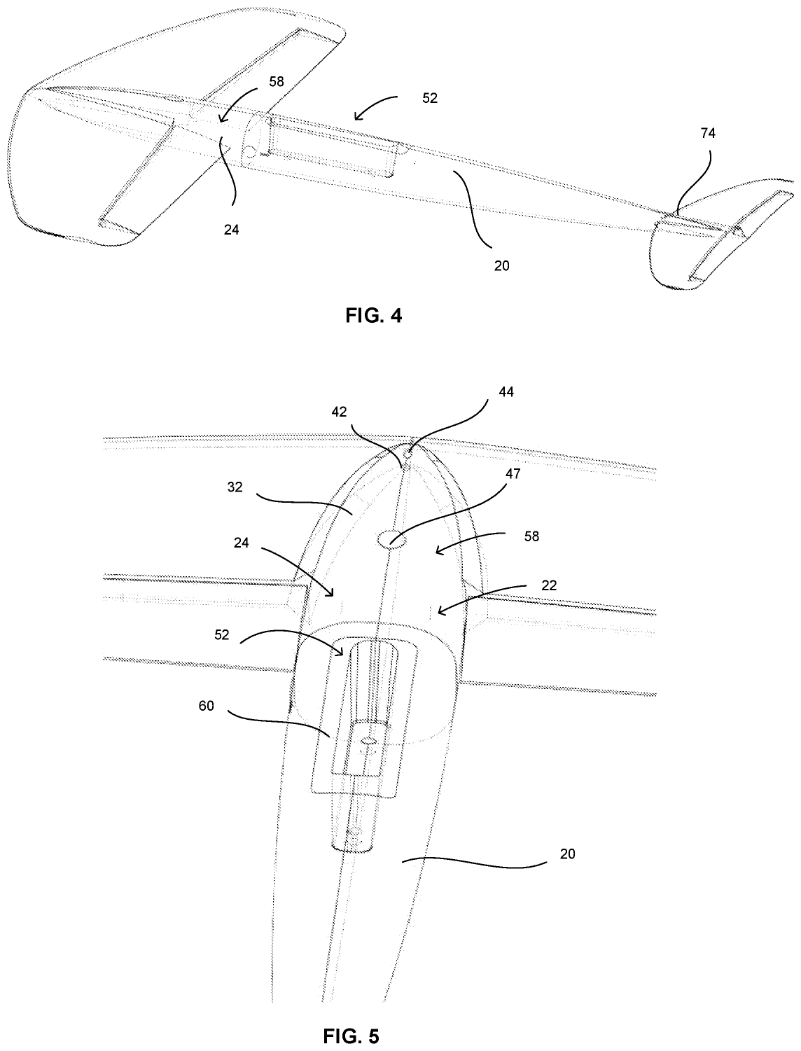

FIGS. 4-5 depict fuselage 20 of hydrofoil pod 10. Fuselage 20 extends longitudinally between front wing 12 and rear wing 16. The leading edge (extending toward front wing 12) comes to a nose 32 that is configured to be received within a receiving portion of front wing 12. Nose 32 is preferably hollow to house electrical components and/or sensors of hydrofoil pod 10. Nose 32 is generally conically tapered such that it limits drag as the foil moves through the water and does not interfere with a lift force created by front wing 12. As shown in FIG. 5, nose 32 may include a pitot tube 42. Pitot tube 42 has an opening 44 and inflow tube (not shown) extending inwardly into nose 32. In use, pitot tube 42 measures the stagnation pressure of the water flowing into the inflow tube. An electronic control unit (ECU) 22 may receive an input relating to the stagnation pressure and calculate a fluid flow velocity to determine the velocity of the hydrofoil as it moves through the water. To perform this calculation, ECU 22 further requires dynamic pressure readings of the water, which can be accomplished through any number of static ports located in fuselage 20 or in front wing 12. Pitot tube 42 may also comprise a Prandtl tube or other tube known in the fluid mechanics arts that calculates fluid flow velocity. This velocity is then communicated to ECU 22 and can be displayed to the operator via any number of displays, sounds, or other notification types.

Nose 32 of fuselage 20 may include at least one sensor, such as sensor 47 depicted in FIG. 5. Sensor 47 may be any one of a Lidar, ultrasonic, pressure, or other sensor type known in the art. Sensor 47 may project a signal up toward the surface of the water to determine a depth of sensor 47 under the waterline. Sensor 47 may also project a signal down toward the bed of the body of water the rider is riding in. This determines the depth of the water and may also signal to a rider of underwater contour changes or other potentially damaging features are within the trajectory of watercraft 92. Additionally or alternatively, the sensor (or another sensor) may be able to project a signal forward to determine the status of the sea state in front of the rider—for instance, whether a larger wave than average or a flat patch of water is approaching. As discussed further below, this information may allow the watercraft 92 to anticipate environmental changes and assist the rider in navigating them.

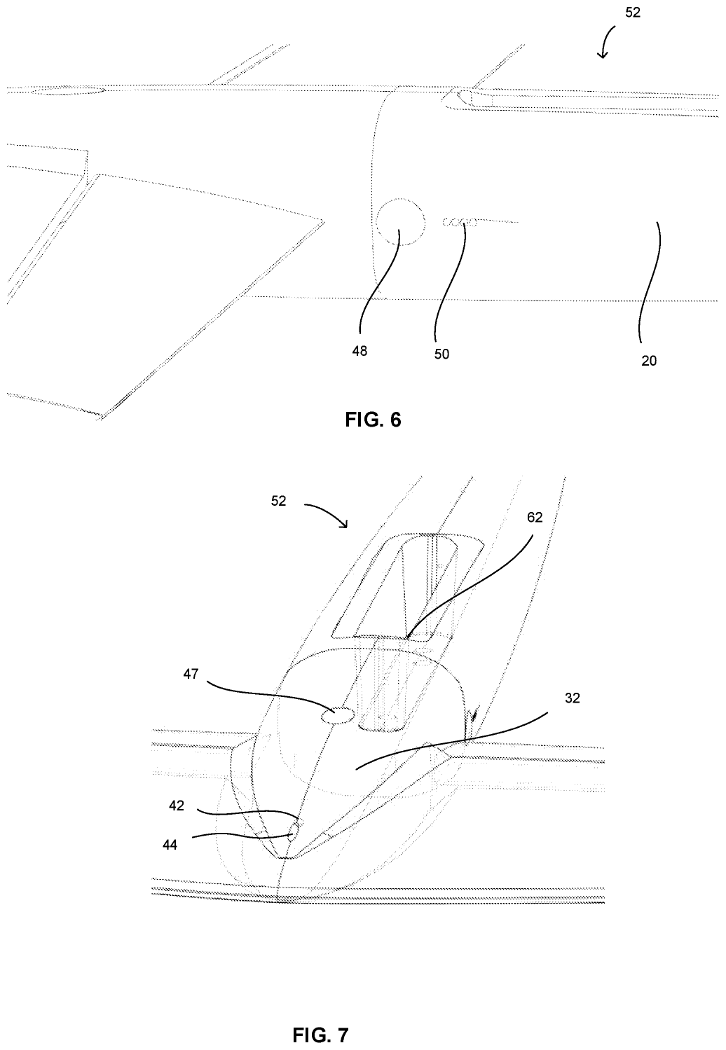

Fuselage 20 may include a series of indicators and buttons on any accessible surface, such as the side surface 46 shown in FIG. 6. For example, button 48 is a power button that powers hydrofoil pod 10 on and off. A series of indicator lights 50 adjacent to button 48 show the charge status of the batteries housed within a hollow cavity 58 of fuselage 20. The lights may be LED, CFL, or other types of lightbulbs adapted to illuminate to show a battery status. A display (not shown) may also be provided to show various aspects of hydrofoil pod 10, such as remaining battery life, software program selection, etc. A waterproofing structure (not shown) may encompass the lights such that they are not damaged by water. Further buttons may be provided to control various aspects of hydrofoil pod 10, such as selecting a software program or putting hydrofoil pod 10 in another mode, like transportation mode.

Continuing rearward on the fuselage 20, an attachment port 52 is preferably located on a top surface 54 to facilitate attachment with a strut 56 (e.g., see FIG. 14). Preferably, strut 56 attaches to attachment port 52 via a quick-connect attachment system (not shown) such as a pressure fit, clip, snap, other attachment types known in the art, or any combination thereof. A quick-connect attachment system would allow a user to quickly interchange the same hydrofoil pod 10 with different watercrafts or to swap hydrofoil pod 10 with another hydrofoil pod on strut 56. An electrical connection port (not shown) may be located within attachment port 52. This port allows for wired connections between the electronics in fuselage 20 and a variety of sensors, gyroscopes, or other electrical devices located in strut 56 or in a watercraft above. The quick-connect locking system includes a seal 60 along its upper edge to prevent water from entering a well 62 when strut 56 is attached to the fuselage 20. In another embodiment, strut 56 is unitarily constructed with hydrofoil pod 10. Strut 56 may also include a propulsion unit 64 to power the watercraft. Such a propulsion unit 64 may be similar to the one described in U.S. Pat. No. 9,586,659, the disclosure of which is incorporated by reference herein. No matter the configuration, propulsion unit 64 may be in communication with ECU 22 and batteries 24 to move the watercraft through the water based on instructions provided by ECU 22 and power provided by batteries 24.

Strut 56 may further include any number of adjustable surfaces along its trailing edge. For instance, flaps may be rotatably coupled to trailing edge in a similar manner to ailerons 14 described above. Flaps may rotate about the longitudinal axis of strut 56 to help as a vertical stabilizer and/or to help stabilize the yaw of hydrofoil pod along the Z-axis. Other orientations of adjustable surfaces located on strut 56 are also envisioned. Strut 56 may further include a number of holes located on any of its outer surfaces. Holes may act as a water inlet as the strut 56 moves through the water. The water may then be passed either up or down strut 56 through a series of tubes and/or cannulations to act as coolant for any electrical components needing cooling. Strut 56 may further include sensors configured to detect at least a distance from the location of the sensor to the surface of the water, a depth of water, surface conditions, and characteristics of incoming waves. Such sensors may be lidar, sonar, or other similar sensors and such sensors communicate with ECU 22 to move various control surfaces throughout hydrofoil pod 10 according to the sensed water conditions.

As depicted in FIGS. 4-5, fuselage 20 is at least partially hollow to allow for electrical components to be housed therein. Fuselage 20 includes cavity 58 located forward of attachment port 52 but rearward of nose 32. Cavity 58 is sealed from the other cavities using conventional sealing techniques, such as bulkheads. This allows for various sections of fuselage 20 to be connected, such as the embodiment depicted in FIG. 3 in which nose 32 is separate from fuselage 20 and attachable thereto. This modularity assists a user in transportation, stowing, cleaning, repairing and modifying the hydrofoil pod 10. Tubular sections 88 may attach in similar ways to the other attachment features described herein, such as via pressure fit quick-connect attachments.

At least one battery 24 is housed within cavity 58. Battery 24 may be any type of battery known in the art, such as Lithium Ion or Nickel-Metal Hydride. Battery 24 is connected to a dock that provides at least a charging port, a terminal for the battery status indicator, and a cooling mechanism. A cooling mechanism may also be provided and may comprise an air-cooling system, such as a fan system, or a water-cooling system. A water-cooling system may include a plurality of tubes extending from fuselage 20 to battery 24. During use, water is pressurized as it is drawn into said tubes and pushed to battery 24. Tubes may then run through a waterproof battery housing box that protects battery 24 while also allowing battery 24 to be cooled by water. Outflow tubes then drain the water out of cavity 58.

In an alternative embodiment, no cooling system is provided for the electrical components of hydrofoil pod 10. Due to the nature of the hydrofoil pod 10 being submerged in water during use, there will be constant water flow over the exterior of hydrofoil pod 10. The external water flow provides convection heat transfer and acts as a means to cool battery 24 and other electrical components of hydrofoil pod 10. Similar cooling also takes place on strut 56 and may act as the sole cooling method for the entire hydrofoil pod 10.

Cavity 58 preferably houses all electrical components required for operation of hydrofoil pod 10, including a flight control system, such as ECU 22 mentioned above. ECU 22 is configured to receive inputs from each of a variety of sensors (discussed below) located throughout hydrofoil pod 10 as well as inputs from a user. Using these inputs, ECU 22 determines outputs that relate to the actuation of flaps located on the wings of hydrofoil pod 10. These adjustments can self-stabilize the watercraft and assist a beginner user while learning to hydrofoil.

ECU 22 may be any type of ECU known in the art. ECU 22 includes a microcontroller and memory (e.g., Flash, RAM, etc.). Further, ECU 22 can receive inputs and outputs, whether the inputs are from sensors located throughout hydrofoil pod 10 or from a user. ECU 22 also includes a communication link, such as a bus transceiver, in which it communicates with various other components of hydrofoil pod 10. For example, a bus transceiver may link the ECU 22 with servo motors configured to actuate the adjustable surfaces in the front wing 12. Bus transceiver further links battery 24 with ECU 22 to provide power to ECU 22. Communication link, like the bus transceiver, may use wires to provide electrical links throughout hydrofoil pod 10, or it may implement wireless technology such as Bluetooth, WiFi, etc. ECU 22 may further receive inputs from a remote control, such as the remote control in U.S. Pat. No. 10,235,870, the disclosure of which is incorporated by reference herein.

ECU 22 is configured to receive embedded software therein. A user may input their own software programs directly to the ECU through a smartphone app, website, firmware update, hard drive, or other inputting method known in the art. ECU 22 may come with software packages preinstalled so that a user needs minimal interactions with hydrofoil pod 10 before use. Software packages may be all-inclusive, such that a single program can last the entire life of hydrofoil pod 10, or software packages may be tailored for specific levels of users. In such an embodiment, hydrofoil pod 10 may have a beginner-oriented software package preinstalled. This software package may limit the maximum speed of the watercraft and provide for a greater number of corrections to the adjustable surfaces on the front and rear wings to provide a more stable riding surface. An advanced rider-oriented software package may be installed at a later date to increase the maximum speed and acceleration of the watercraft and decrease the automated corrections to provide a riding surface more responsive to user inputs. These control methods will be described in further detail below.

ECU 22 may be a readily available unit such as a flight controller. Examples of readily available flight controllers include those manufactured by Pixhawk and Auterion in Moorpark, Calif., such as the Pixhawk 1, those manufactured by Matek Systems in Shanghai, China, such as the F405-VTOL, and the like. Such flight controllers may be implemented with hydrofoil pod 10 directly or may first be modified to tailor the riding experience to hydrofoils rather than aircraft. These modifications may involve setting the system to receive inputs from the various sensors throughout hydrofoil pod 10 that account for various water conditions in addition to the air conditions that flight controllers typically account for, and to modify at least the speed, height, and stability of hydrofoil pod 10 in water. Alternatively, instead of implementing a readily available flight controller such as those mentioned above, various components of flight controllers may be incorporated to achieve a desired ECU 22. Regardless of the type of ECU 22 implemented with hydrofoil pod 10, it is preferable to pre-set the ECU 22 such that a user needs to make minimal adjustments to ECU 22 before operating hydrofoil pod 10. Such minimal adjustment may include selecting a vessel type (e.g., surfboard e-foil, jet-ski e-foil) and a user's skill level. Modifying or otherwise tailoring the ECU 22 may be particularly important here as the user skill level will likely be lower than average, and thus the ECU 22 should be capable of utilizing a number of inputs to provide appropriate control of the vessel for the user.

Additional modifications may be made to the commercialized flight controllers to make them more suited for hydrofoils. While many flight controllers have pre-configured flight modes for different types and levels of flight stabilization, autopilot features, etc., these flight modes are designed for use in the air. Because air has different turbulences than water, the pre-configured flight modes can be modified to account for the turbulences in water, such as currents and waves, that may differ from wind patterns in the sky. Thus, rather than accounting for differences in altitude of an aircraft's takeoff and cruising altitude, a modified flight controller can account for the height of waves, the depth of water, and the height of the riding platform above the surface of the water. Additionally, stabilization modes may differ in water than in the air. In situations where waves are traveling in multiple directions, the modified flight controller may continuously modify a course of the watercraft to steer a user into waves such that the impact from the waves is lessened.

Similar to conventional flight controllers, modified flight controllers for e-foils may utilize autopilot or semi-autopilot modes that allow a user to focus on riding the foil rather than operating the foil. This is particularly advantageous for beginners, who may struggle with both learning the coordination of using an e-foil and operating the e-foil. Accordingly, the modified flight controllers may have beginner-friendly autopilot modes that operate the e-foil at slower speeds with the highest levels of stability to allow the user to gain experience in operating the e-foil. As such, the sensor system within the hydrofoil pod may sense structures within the water, such as sand bars, that should be avoided and modify the course of the e-foil around the structures to avoid a collision. In this manner, the flight controller may be modified from conventional flight controllers to sense underwater structures and contours that otherwise do not exist in the air and either warn the user of such features or steer the watercraft around them.

The flight controllers may also be modified to account for multiple watercrafts riding together. Examples of such arrangements include three users, each riding their own hydrofoil surfboard. In this arrangement, the flight controller of one watercraft may communicate with the flight controllers and remotes of the other watercraft and direct the watercrafts to stay in a particular formation, avoid collisions, or the like. This setting may be used with an autopilot setting to allow each of the users the ability to focus on learning and riding their respective watercrafts without focusing on navigating or controlling the watercrafts.

The flight controllers preferably include at least one failsafe in the instance where a user needs to quickly cease operation of the e-foil. Such a failsafe may include a user falling off the e-foil and pulling a kill switch, or the e-foil sensing the water conditions are unsafe to enter a foiling mode.

Cavity 58 may also house a number of motors to actuate various adjustable surfaces throughout the hydrofoil pod 10. In that embodiment, various gearboxes (not shown) may be spaced throughout hydrofoil pod 10 to transfer rotary motion to the adjustable surfaces located on the wings. Alternatively, motors may be placed adjacent their respective adjustable surface. An example of that embodiment is a motor located directly adjacent to an aileron 14 on front wing 12. The motor may actuate both ailerons 14, or multiple motors may be provided to independently control each aileron on each side of fuselage 20 (or multiple motors to independently control multiple ailerons on either side of fuselage 20). Motors are in communication with ECU 22 and may be servos, DC brushed, DC brushless, or other motor types known in the art.

Cavity 58 may further house a receiver configured to receive inputs from a remote control. This remote control and receiver may be similar to those described in U.S. Pat. No. 10,235,870, the disclosure of which is incorporated by reference herein. The receiver is in communication with the communication link, which allows the data from the receiver to be received by ECU 22.

Although the embodiment depicted in FIG. 5 shows all electrical components necessary for operation housed in cavity 58 of fuselage 20, other orientations are feasible. For example, different electrical components may be placed in their own unique cavities in fuselage 20, each cavity separated and sealed from the other via bulkheads. Further, each of the electrical components in cavity 58 may be interchangeable so that a user may change components as desired.

Weights, alternatively referred to as ballasts, may be provided in various cavities of fuselage 20. Ballasts provide additional balance to hydrofoil pod 10 and may allow a rider a more stable riding experience. Once a user becomes more experienced at riding a personal watercraft with a hydrofoil, ballasts may be removed from fuselage 20 to decrease its weight and increase the hydrofoil's maneuverability and accelerations. Ballasts may be placed at any location within fuselage 20, such as in cavity 58.

Moving rearward, and continuing with the embodiment of FIG. 1, fuselage 20 tapers at a rear end to define tail 74. Tail 74 is generally conical to promote aerodynamics and limit drag as the hydrofoil moves through the water. Tail 74 is further configured to attach to rear wing 16. Rear wing 16 preferably includes two rear wings 16a, 16b, one wing transversely disposed on each side of tail 74 and extending outwardly from tail 74. Rear wings 16a, 16b, may attach to tail 74 in a similar manner to front wings 12a, 12b, described above. Preferably, rear wings 16a, 16b attach to tail 74 without the use of fasteners, such as with a friction fit or a connection via clamps as noted above. Rear wings 16a, 16b may further contain a groove 90a, 90b that corresponds to a protrusion extending laterally from tail 74. Protrusions extending from tail 74 may fit into grooves 90a, 90b to guide and secure each of rear wings 16a, 16b in place.

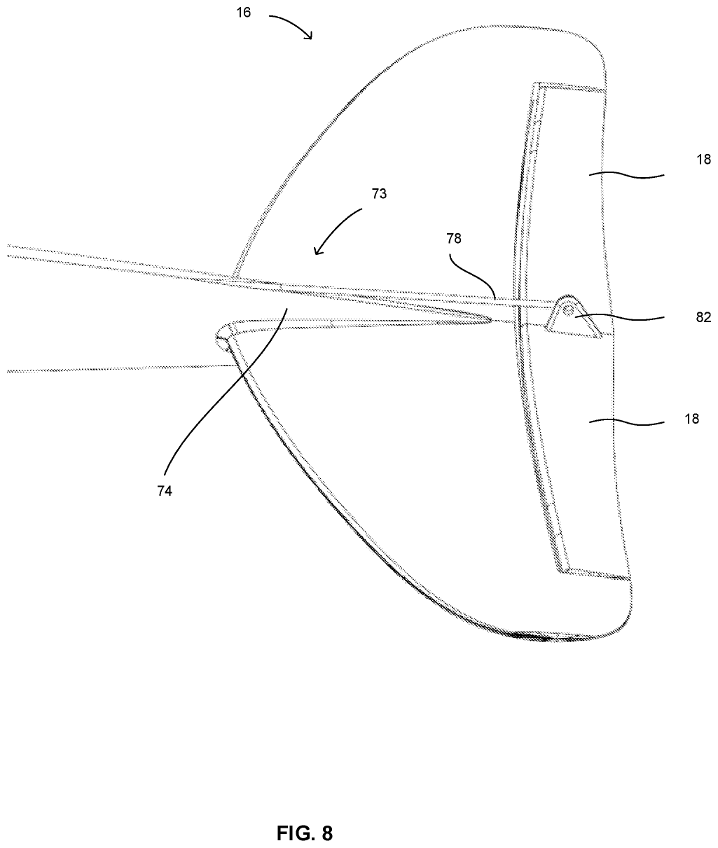

An alternative embodiment of rear wing 16 is a monolithic rear wing 16, such as the monolithic wing illustrated in FIG. 8. In this embodiment, rear wing 16 is unitarily constructed such that grooves and protrusions are not needed to attach rear wing 16 to tail 74. In this embodiment, a receiving portion of rear wing 16 can attach to the entire tail 74. This attachment can be facilitated with quick-connect attachment features like those described herein, or with fasteners or other connection methods known in the art.

Continuing with the embodiment illustrated in FIG. 8, rear wing 16 may be shaped substantially similarly to front wing 12, described above. Rear wing 16 may have a convexly-curved top surface (positive camber) and a substantially flat bottom surface, or it may have a positive camber top surface and a positively cambered bottom surface. Rear wing 16 is primarily designed to stabilize the pitch of hydrofoil pod 10 along the Y-axis, and thus may not require a particular shape that generates substantial lift like front wing 12 requires. Rear wing 16 extends transverse to the longitudinal axis of fuselage 20 and has an overall length that is preferably less than the overall length of front wing 12.

A purpose of rear wing 16 is to provide horizontal stabilization and control the pitch, or trim, of hydrofoil pod 10 along the Y-axis. To provide further control and stabilization, rear wing 16 may include one or more adjustable portions or surfaces, such as elevators 18, which may be rotatably coupled to the rear surface of rear wing 16. Elevators 18 may be rotatably coupled in a similar manner as ailerons 14 on front wing 12 and are employed to control the pitch of hydrofoil pod 10 as it moves through the water. As shown in FIG. 2, elevators 18 may be in a pair, one elevator 18 located on each side of tail 74. In another embodiment, elevators 18 may be in a different configuration such as a single elevator spanning the entire trailing edge of rear wing 16 or more than two elevators spaced along the trailing edge of rear wing 16.

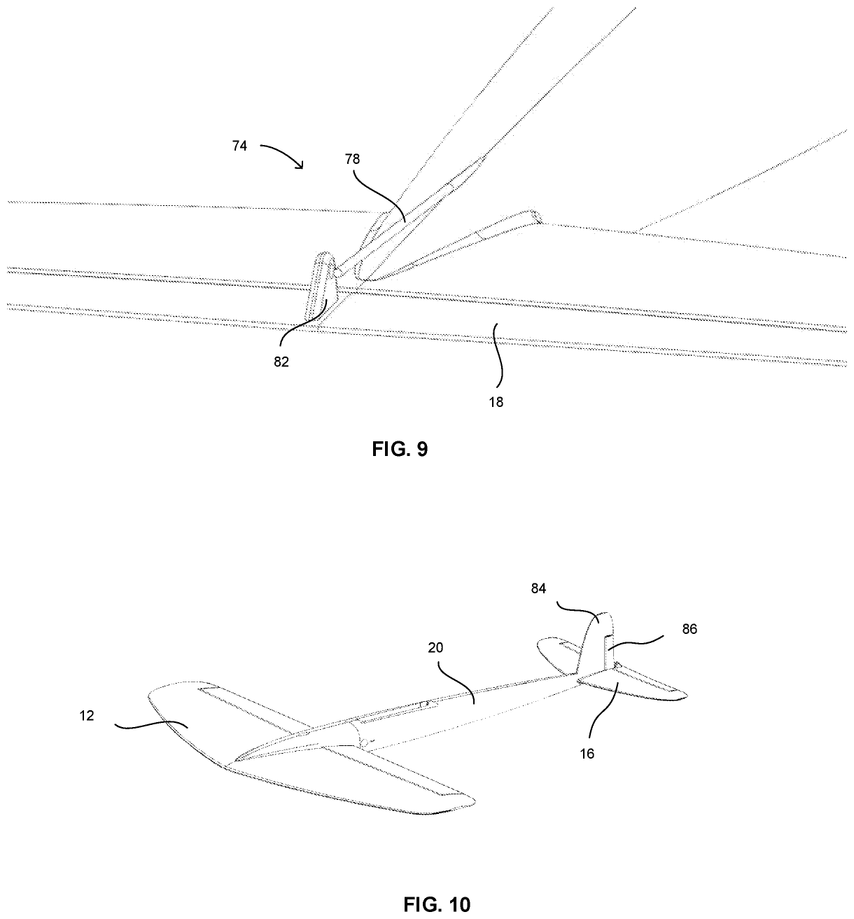

In one embodiment, elevator 18 may be actuated via a push-pull rod system 76 like that shown in FIGS. 8-9. Push-pull rod system 76 includes an elongate arm 78 with an eyelet disposed on each end. The forward-facing end of arm 78 is attached to a motor, such as a servo motor, disposed within a cavity of fuselage 20. The rearward-facing end of arm 78 is attached to structure 82. Structure 82 extends upward from a surface of either the tail 74 or the rear wing 16 and facilitates the conversion of the pushing force from arm 78 to a rotational force to actuate elevators 18. This conversion may be accomplished via gears or methods known in the art. Structure 82 may output a rotational force to multiple elevators if there are two or more, preferably independently of each other.

In another embodiment, such as is illustrated in FIG. 10, tail 76 may also include a vertical stabilizer 84, alternatively referred to as a tail fin, which may extend upward from the tail 74 of fuselage 20. Vertical stabilizer 84 is substantially flat to provide an aerodynamic profile to the hydrofoil pod 10. Vertical stabilizer 84 is employed to stabilize the aircraft in the yaw direction along the Z-axis. Rudder 86 may be rotatably mounted to the trailing edge of vertical stabilizer 84. Rudder 86 may be attached using similar hinge mechanisms to those described for the ailerons of front wing 12 and elevators of rear wing 16. Rudder 86 provides additional stabilization and control to the watercraft's yaw. Rudder 86 may be actuated via a push-pull rod similar to the one described for the elevators 18 above, or by another method such as by servo motors causing direction rotation of rudder 86.

In addition to the sensors described herein, other various sensors may be located at points throughout hydrofoil pod 10. These sensors may be inertial measurement unit sensors (IMU), accelerometers, gyroscopes, piezoelectric, magnetometers, temperatures, ultrasonics, barometric pressure, Lidar, or any other conceivable sensor type known in the art. These sensors may be placed at optimal locations like the nose 32 of fuselage 20, tail 74 of fuselage 20, center of gravity point of hydrofoil pod 10, and any other location that would provide readings relating to at least the speed, orientation, rotational forces, temperature, pressure, depth, other metrics of hydrofoil pod 10 and its accompanying watercraft, or other metrics of the surrounding environment. Each sensor employed in hydrofoil pod 10 is in communication with ECU 22 to help stabilize and modify a course of the watercraft.

A preferred embodiment of hydrofoil pod 10 is using it as a standalone electronically driven hydrofoil (e-foil) that includes all required electronics to power a personal watercraft 92, such as a surfboard, and assist a user in providing a steadier and more forgiving hydrofoil experience, particularly for those just learning how to use such a hydrofoil watercraft. However, another advantage of hydrofoil pod 10 is that it could be attached to other watercrafts that do not require electrical propulsion. Surfboards, sailboats, and windsurf boards are capable of achieving speeds that would create sufficient lift to lift the watercraft out of the water if a hydrofoil was attached thereto. Thus, a rider could attach hydrofoil pod 10 directly to any compatible non-motorized watercraft and use the watercraft with a standard foiling mode. This is advantageous and cost-effective further because a user would not need to purchase a new hydrofoil and propulsion unit for each watercraft they desire to operate. Further to this embodiment, because hydrofoil pod 10 does not require additional electronics or power sources to operate, it could be attached to a non-motorized watercraft (like a standard surfboard) and the stabilization features described herein can be employed to stabilize the surfboard even though the surfboard is not being electronically propelled through the water.

Each structural component, e.g., front wing 12, can be made of material that is strong enough to withstand the forces attributed to hydrofoiling but light enough to decrease the weight of the overall hydrofoil pod 10 and allow for better maneuverability. Such materials may be fiber-reinforced epoxy (reinforced with glass, carbon, or Kevlar fibers), extruded aluminum, ultra-high molecular weight polyethylene (UHMWPE), or other materials known in the art. Depending on the material, the components may be molded, extruded, 3D-printed, or formed via another manufacturing process known in the art.

As mentioned throughout, an embodiment of hydrofoil pod 10 is a monolithic construction of hydrofoil pod 10. In that embodiment, each of front wing 12, fuselage 20, rear wing 16, and vertical stabilizer 84 are manufactured as a single piece. It is also envisioned that strut 56 is unitarily constructed with the remaining components. Alternatively, each component may be manufactured separately and then assembled. Using the latter approach, different materials could be used for each component to provide the certain benefits that each material encompasses.

An exemplary method and examples of using hydrofoil pod 10 are described herein. The method described herein refers to a user using a hydrofoil surfboard with an electric propulsion system, but it is envisioned that this method can apply to any watercraft, whether or not the watercraft is being propelled through the water.

In such an exemplary method, a user must first attach hydrofoil pod 10 to a watercraft. This attachment ideally takes place using quick-connect attachment features. If the components, such as front wing 12 and rear wing 16 of hydrofoil pod 10 are separated, the user must also attach each component to hydrofoil pod 10. The user may then select an appropriate ride setting in ECU 22 based on the user's skill setting. For example, hydrofoil pod 10 may have a beginner software package preinstalled such that a user would not need to make any adjustments to hydrofoil pod 10 before use.

Once hydrofoil pod 10 is attached to a watercraft, a user may begin riding the watercraft. Using a controller like the controller described in U.S. Pat. No. 10,235,870, the disclosure of which is incorporated by reference herein, a user may increase the throttle to provide forward propulsion to the watercraft. As the watercraft begins to move through the water, it will remain on the surface of the water until a certain speed is reached. Once a speed high enough for a lifting force to be generated by front wing 12 is reached, the watercraft will rise above the surface of the water.

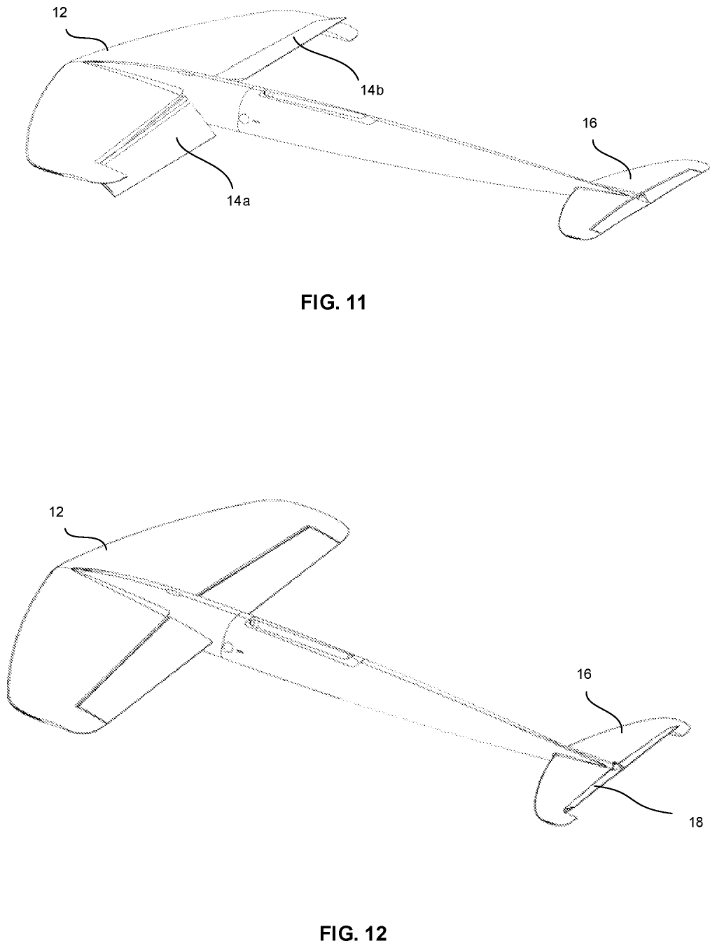

As a beginner, a user may struggle to balance on the surfboard while the watercraft 92 is in foiling mode. Hydrofoil pod 10 assists with that. For example, if a user steps too far forward on the surfboard during foiling mode, various sensors located throughout hydrofoil pod 10 will sense the nose of the watercraft is pitching down. To counteract the downward pitch, ECU 22 will output a signal to elevator 18 on horizontal stabilizer 16. For downward pitch, elevators 18 will rotate up as illustrated in FIG. 11 to force the tail 74 down and nose 32 up. Conversely, if a user was standing too far back on the surfboard such that its nose was pitched too high, the ECU would receive an input from a sensor and send a signal to elevators 18 to rotate downward, which forces the tail to rise and the nose 32 to lower.

Similar adjustments happen if the user steps too far to one side or the other, or to assist the user to make a smooth turn. If sensors in hydrofoil pod 10 detect the roll angle of the watercraft to be too steep, sensors will communicate with ECU 22 to send a signal to ailerons 14 on front wing 12. To counteract a rolling force of the watercraft to the left, or a counterclockwise rolling force, the left aileron 14 will rotate down and the right aileron 14 will rotate up, as illustrated in FIG. 11. Once the sensors of hydrofoil pod 10 detect the watercraft is stable again, ailerons 14 can return to their neutral position. Conversely, to counteract a rolling force to the right, ECU 22 may send a signal directing the left aileron 14a to rotate up and right aileron 14b to rotate down.

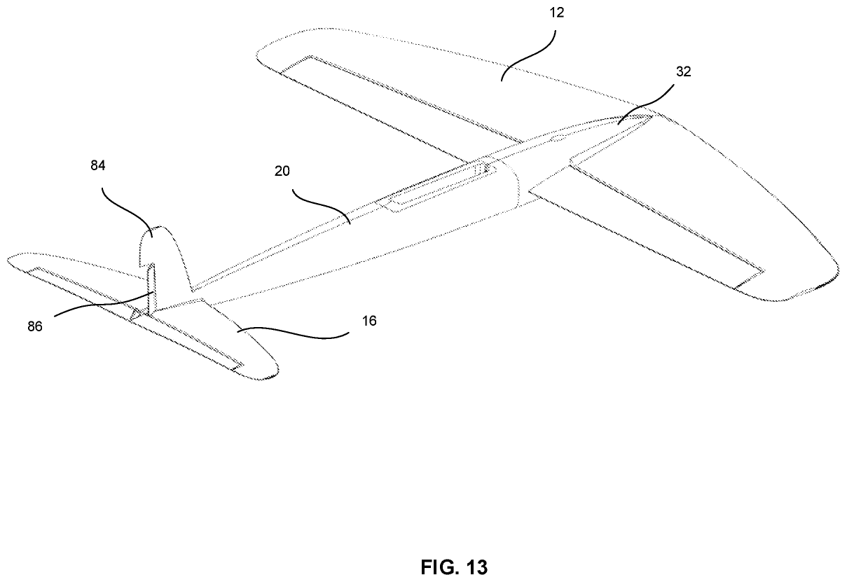

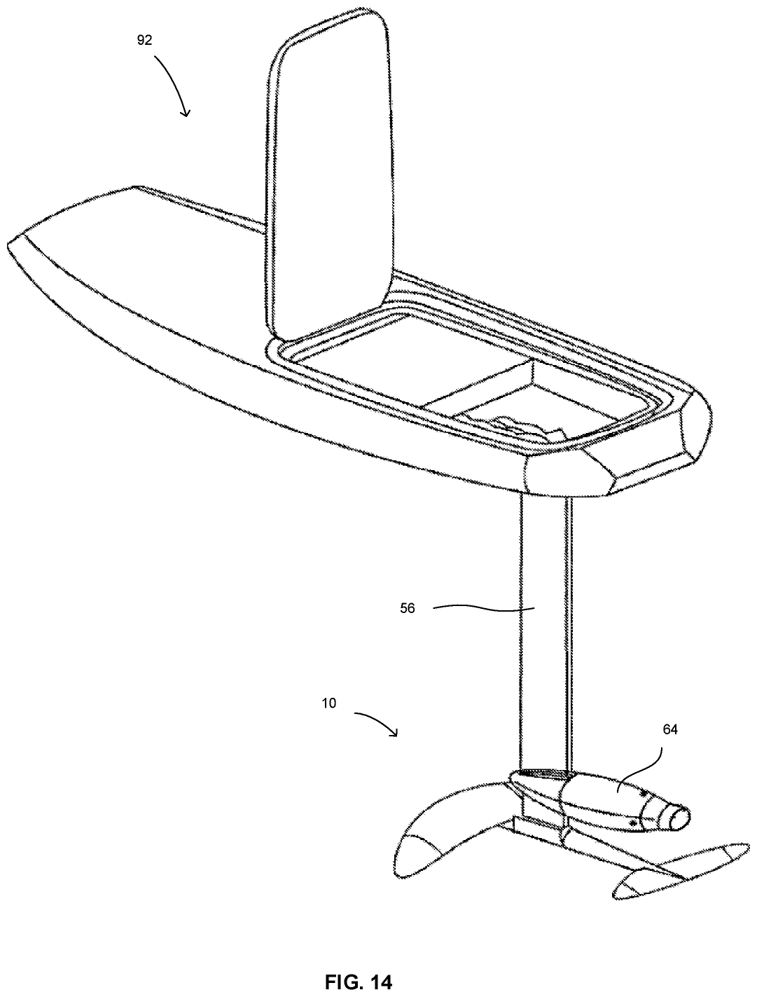

Similar adjustments also take place for a change in yaw of the watercraft. If sensors of hydrofoil pod 10 detect a severe change in yaw angle of the watercraft, the sensors will communicate to ECU 22 which in turn communicates with rudder 86 of vertical stabilizer 84. For example, to counteract a yaw force to the left, rudder 86 may turn to the right as shown in FIG. 13. Conversely, to counteract a yaw force to the right, rudder 86 may turn left. Similar controls may be employed for rudders located on strut 56.

A user may steer hydrofoil pod 10 using any combination of aileron 14, elevator 18, and rudder 86 control. For example, to steer the watercraft to the right, user may solely control the rudder and cause it to pivot to the right. If a tighter turn at higher speeds is required, a user may employ both rudder 86 and aileron 14 to input a rolling force along with the turning force. While these turns are happening, sensors of hydrofoil pod 10 may communicate with ECU 22 to actuate any number of adjustable surfaces on hydrofoil pod 10 to counteract any imbalance taking place.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A training hydrofoil system for connection with a watercraft comprising:
a first wing including at least one adjustable surface;
a second wing including at least one adjustable surface;
a fuselage extending longitudinally and the first wing and the second wing connected to the fuselage and extending latitudinally relative to the fuselage, the fuselage including an attachment feature for attaching to the watercraft;
an electronic control unit capable of actuating at least one adjustable surface to modify a course of the watercraft; and
a power source, the power source and the electronic control unit positioned in the fuselage.

2. The system of claim 1, wherein the power source is a battery.

3. The system of claim 1, further comprising at least one sensor, the at least one sensor being at least one of a Lidar sensor, a barometric pressure sensor, a gyroscope, and an ultrasonic sensor.

4. The system of claim 3, wherein the sensor is configured to determine at least a depth of the system in water, surface conditions of the water, an angle of the watercraft corresponding to a roll, pitch, and yaw axis, and a velocity of the watercraft, and to communicate a corresponding output to the electronic control unit.

5. The system of claim 4, wherein the sensor is capable of communicating with the electronic control unit to provide data to the electronic control unit and the electronic control unit is capable of using the data to actuate the at least one adjustable surface to modify the course of the watercraft.

6. The system of claim 1, wherein the first wing is positioned towards a leading portion of the system relative to the second wing, the first wing configured to provide lift to the system.

7. The system of claim 6, wherein the at least one adjustable surface of the first wing includes two ailerons, one aileron positioned along trailing portions of the first wing on each side of the fuselage and configured to independently rotate based on a signal from the electronic control unit.

8. The system of claim 1, wherein the second wing is positioned towards a trailing portion of the system relative to the first wing, the second wing configured to provide horizontal stabilization to the system.

9. The system of claim 8, wherein the at least one adjustable portion of the second wing includes two elevators, one elevator positioned on each side of the fuselage and each elevator configured to independently rotate based on a signal from the electronic control unit.

10. The system of claim 1, further comprising a vertical stabilizing fin positioned at a rear end of the fuselage with at least one rudder positioned thereon, the at least one rudder configured to rotate to provide vertical stabilization to the system.

11. The system of claim 10, wherein the sensor is configured to communicate with the electronic control unit to determine a stabilization pattern and a modified course of the watercraft and to actuate the at least one adjustable surface the at least one rudder to control a roll, pitch, and yaw of the watercraft.

12. The system of claim 1, wherein the attachment feature is a quick-connect attachment configured to receive a strut.

13. A hydrofoil system for attaching to a watercraft comprising:
a first wing including at least one aileron;
a second wing including at least one elevator;
a fuselage extending longitudinally between the first wing and the second wing and connected to the first wing and the second wing, the first wing and second wing extending latitudinally relative to the fuselage;
at least one sensor;
an electronic control unit capable of actuating the at least one aileron and at least one elevator to modify a course of the watercraft; and
a power source, the power source and the electronic control unit positioned in the fuselage.

14. The system of claim 13, further comprising a vertical stabilizer extending from the fuselage and including at least one rudder configured to rotate based on an input from the electronic control unit.

15. The system of claim 13, wherein the electronic control unit and the power source are positioned in separate waterproof compartments within the fuselage.

16. The system of claim 14, further comprising at least one servo motor for each of the at least one aileron, at least one elevator, and at least one rudder, the at least one servo motor in communication with the electronic control unit.

17. The system of claim 16, wherein the electronic control unit communicates to the at least one servo motor via Bluetooth.

18. A method of operating a hydrofoil comprising:
powering the hydrofoil from a power source positioned in a fuselage of the hydrofoil;
sensing an orientation of the hydrofoil via at least one sensor located in the hydrofoil;
communicating the orientation of the hydrofoil from the at least one sensor to an electronic control unit positioned in the fuselage;
actuating at least one aileron on a first wing based on the orientation of the hydrofoil, the first wing extending transversely to a longitudinal axis of the fuselage and connected to the fuselage; and
actuating at least one elevator on a second wing based on the orientation of the hydrofoil, the second wing extending transversely to a longitudinal axis of the fuselage and attached to the fuselage.

19. The method of claim 18, further comprising actuating at least one rudder on a vertical stabilizer based on the orientation of the hydrofoil, the vertical stabilizer positioned on a rear end of the fuselage and orthogonally extending from the fuselage.

20. The method of claim 18, further comprising determining a stabilization correction based on the orientation of the hydrofoil and rotating at least one of the aileron, elevator, and rudder to stabilize the hydrofoil.
